(19) United States
(12) Patent Application Publication
(10) Pub. No.: US 2010/0102463 A1
(43) Pub. Date: Apr. 29, 2010

(54) Method For Mixing A Fluid With At Least One Further Substance And Degassing The Mixture And For Delivering The Mixture

(76) Inventor: Roman Arnet, Ennetbuergen (CH)

Correspondence Address: Nixon Peabody LLP, P.O. Box 60610, Palo Alto, CA, 94306, US

(21) Appl. No.: 12/530,198

(22) PCT Filed: Mar. 3, 2008
(86) PCT No.: PCT/EP2008/052541

§ 371 Date: Sep. 4, 2009

(30) Foreign Application Priority Data
Mar. 6, 2007 (EP) 07103597.6

(51) Int. Cl. B29D 11/00; B01F 13/06; G05D 11/04

(52) U.S. Cl. 264/1.1; 366/139

(57) ABSTRACT

A fluid is mixed with at least one further substance, the fluid mixture is degassed and delivered in such a way that the mixture is prepared in a preparation phase with the following steps:
providing at least two starting substances in separate containers, with at least one of the starting substances being a fluid,
conveying one starting substance after the other from its container into the tank, with each individual filling quantity being measured with a weighing cell, and
stirring of the substances in the tank in order to mix and degas the filled substances;
   and pressurizing the tank with compressed air in a production phase in order to supply fluid from the tank to an output line provided with a process valve.

### CROSS REFERENCE TO RELATED APPLICATIONS

The present application is related to and claims priority based upon PCT patent application no. PCT/EP2008/052541 entitled “Method for mixing a fluid with at least one further substance and degassing the mixture and for delivering the mixture”, filed Mar. 3, 2008, which in turn claims priority of the European patent application no. 07103597.6 filed Mar. 6, 2007.

### TECHNICAL FIELD

The invention relates to a method for mixing a fluid with at least one further substance and degassing the mixture and for the delivery of the mixture.

### BACKGROUND OF THE INVENTION

There are various applications in which a fluid and at least one further substance, e.g. a further fluid, are brought together and need to be mixed, whereby no bubbles must be produced. Such an application is for example the production of lenses by casting. A fluid monomer, which can be a single fluid or a mixture consisting of at least two fluids, is poured into a cavity delimited by two molds and a seal and is polymerized, with the lens thus being obtained. The problem repeatedly arises that the finished lens has enclosed air bubbles and/or streaks. In order to prevent this, the monomer must be degassed before pouring into the cavity.

The European patent application EP 671254 refers to a then conventional method for degassing a monomer, in which the monomer is filled into a rotary evaporator where the monomer is simultaneously stirred and subjected to vacuum during a predetermined period of time. The air bubbles contained in the monomer thereby escape and will be drawn off. Thereafter, the monomer is stored under nitrogen atmosphere until it is used for casting the lenses. The disadvantages of this method are according to EP 671254 that the storing under nitrogen atmosphere can lead to the consequence that only oxygen is replaced by nitrogen and that it needs to be ensured with utmost care during casting that the monomer does not come into contact with oxygen as otherwise it will absorb oxygen immediately. A further disadvantage is that during the degassing under oxygen other substances contained in the monomer will escape and can thus change the composition of the monomer. EP 671254 therefore proposes a method for degassing in which the monomer is pumped from the tank through a degasifier to the mold cavity. The monomer is therefore degassed during the production phase directly before filling into the cavity. The degasifier consists of tubes of air-permeable material which are stored in a vacuum chamber.

These two methods have also been cited in the international patent application WO 03/074149 and have been described there as rather unsuitable. WO 03/074149 discloses a new degasifier which replaces the degasifier of EP 671254.

In these three described methods, either the monomer or the finished monomer mixture is degassed before casting.

U.S. Pat. No. 5,973,098 describes a polymerizable mixture which consists of two substances and is suitable for the production of lenses. The two substances are supplied through two syringes in portions to a mixing chamber and are mixed there with each other by stirring. The mixing chamber can be under vacuum. Thereafter, the mixture is pressed by means of an inert gas from the mixing chamber into the mold cavity. The disadvantageous aspect in this method is that a sufficient degassing takes relatively long, even when an only small portion is concerned.

The international patent application WO 2005/084927 describes a process in which two substances are supplied to a mixing chamber and are then pressed by means of a piston into the mold cavity. The mold cavity is formed in such a way that air bubbles, if any, can escape. Degassing prior to casting of the monomer does not occur here.

An optical material suitable for lenses is known from EP 1316819. The substances required for producing the material are given into a tank and mixed. The mixture is subjected to vacuum before, during and/or after the mixing in order to degas the mixture. The mixture is then cast in a mold and polymerized.

A method is known from JP 61111130 in order to mix and degas different fluids. The quantities of the fluids supplied to the tank are controlled via valves and pumps.

The invention relates to the bringing together and mixing at least two fluid substances and the degassing of the mixture. The invention is suitable for example for producing lenses by casting, in which a mixture consisting of at least two fluids is filled into a mold cavity. The fluids can be retained individually over longer periods of time. The mixture on the other hand can be retained only over a period of a few days.

### SHORT DESCRIPTION OF THE INVENTION

The invention is based on the object of developing a method for bringing together and mixing at least two fluid substances and the degassing of the mixture.

The invention is explained by reference to a selected embodiment. The embodiment relates to the production of lenses by casting, in which a fluid provided in a tank is supplied by application of pressure through an output line to a hollow needle whose tip opens into a mold cavity delimited by two molds and a sealing element. The mold cavity is upwardly open and is under atmospheric pressure. The fluid is a mixture of a fluid and one further substance which can be fluid or powdery. The method in accordance with the invention comprises a preparation phase in which the fluid is brought together with the at least one further substance, mixed and degassed, having the steps:
A) Providing at least two starting substances in separate containers, with at least one of the starting substances being a fluid;
B) conveying one starting substance after the other from its container into the tank, with each individual filling quantity being measured with a weighing cell, and
C) stirring of the substances in the tank in order to mix and degas the filled substances;
   and a production phase in which the tank is pressurized with compressed air in order to supply the fluid mixture from the tank to an output line, having the method steps:
D) opening of a process valve arranged in the output line in order to start the delivery, and
E) closing of the process valve in order to stop the delivery.

Step B) is especially important because already slight deviations from the predetermined percentages of the individual starting substances have a strong influence on the quality of the lenses. The weighing cell must be capable of measuring with a precision of grams under a load with a weight of several kilograms.

For casting a lens, the process valve arranged in the output line between the tank and the hollow needle is opened and closed again once the mold cavity is filled.

Preferably, the mixture in the tank is mixed at first with a first stirring speed in step C) and thereafter degassed with a second stirring speed, with the second stirring speed during the degassing being smaller than the first stirring speed during mixing.

The pressure level in the tank can be adjusted when required to changing requirements. When casting lenses, the narrowest point in the filling opening of the mold cavity determines for example with which flow speed the fluid can be supplied without producing any back-ups and the mold cavity being overflown. In order to enable keeping the time for the filling as short as possible, the pressure level of the pressure exerted by the compressed air in the tank is advantageously brought to a value prior to the casting of the lens which depends on the distance at the narrowest point of the filling opening, with the pressure level increasing continuously or in discrete steps with increasing distance.

The temperature prevailing in the interior of the tank is preferably adjusted at least during the production phase to a predetermined value, so that the fluid has optimal viscosity.

It is also advantageous to pump the substances in step B in an apportioned manner into the tank, so that the foam development remains as low as possible.

A further hollow needle is advantageously used during the casting of the lenses as a sensor for detecting when the mold cavity is filled with fluid, which further needle is provided with air so that permanently a low flow of air escapes from the hollow needle. Once the fluid in the mold cavity reaches the tip of the hollow needle, the pressure in the interior of the hollow needle will rise. This rise in pressure is measured and is used for generating the closing command for the process valve.

The invention is explained below by reference to an apparatus suitable for performing the method and the drawing in an exemplary way. The example relates to an apparatus for casting lenses. The apparatus can also be used in an analogous manner for other applications in which a fluid is to be mixed with other substances without producing bubbles in the mixture. In this example fluids are mixed.

### DESCRIPTION OF THE DRAWINGS

FIGS. 1, 2 show a perspective and schematic representation of an apparatus suitable for performing the method in accordance with the invention and

FIG. 2 further shows a sectional view of a mold cavity, and

FIG. 3 shows a sectional view of a further mold cavity.

### DETAILED DESCRIPTION OF THE INVENTION

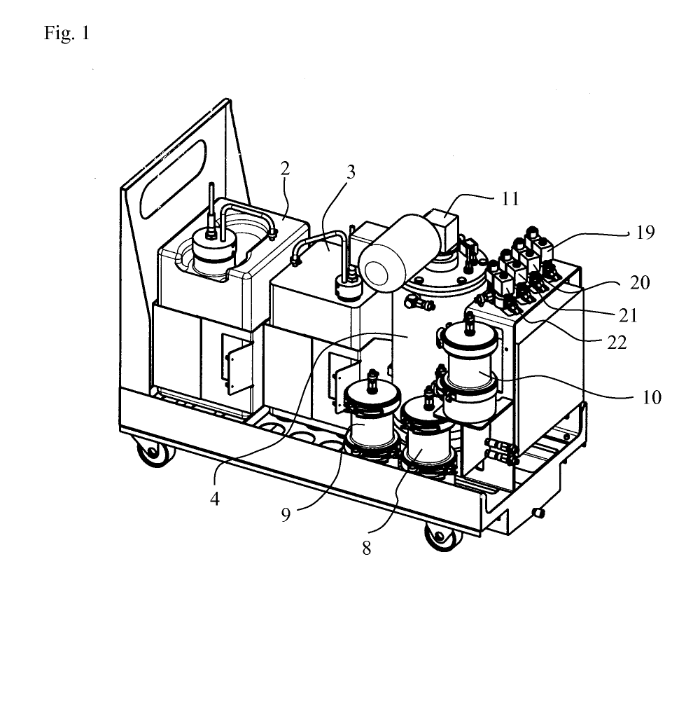

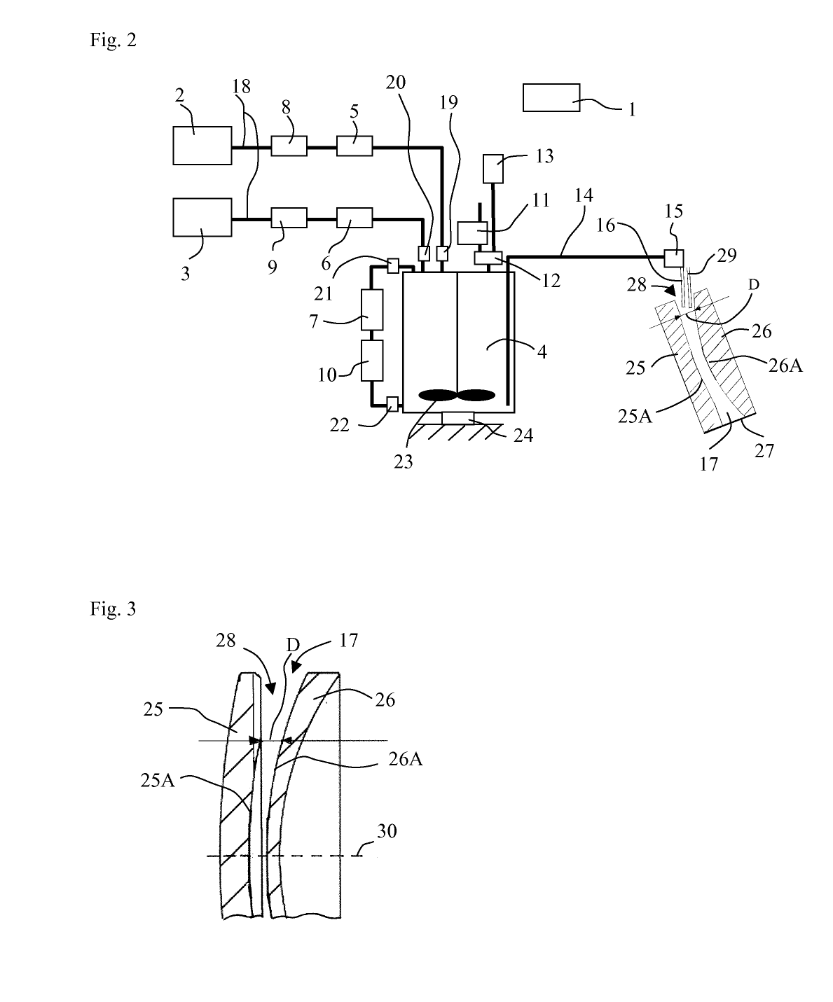

FIG. 1 shows a perspective illustration of an apparatus suitable for performing the method in accordance with the invention. FIG. 2 shows the apparatus schematically and not drawn to scale. In this example, the apparatus is placed on a trolley and is used in a fully automatic machine for the production of lenses. The apparatus comprises a control device 1, two places for receiving one container 2 and 3 each with the starting substances, a temperature-controlled tank 4, three filters 5, 6 and 7, three pumps 8 to 10, a pressure regulator 11, a changeover valve 12 which connects the tank 4 either with the pressure regulator 11 or a vacuum source 13, an output line 14 with a process valve 15 and a hollow needle 16 through which the monomer mixture to be filled into a mold cavity 17 is delivered, and various connecting lines 18 and further valves 19 to 22. An agitator 23 is integrated in tank 4. The tank 4 is disposed on a weighing cell 24, e.g. a weighing cell from the company Pesa. Tank 4 loads the weighing cell 24 with its weight. The pressure regulator 11 is supplied with compressed air.

The three pumps 8 to 10 are preferably membrane pumps. The first membrane pump 8 is used to pump fluid from the first container 2 through the first filter 5 and the first valve 19 into the tank 4, with possible impurities of the fluid remaining in filter 5. The second membrane pump 9 is used in an analogous fashion to pump fluid from the second container 3 through the second filter 6 and the second valve 20 into the tank 4. The membrane pumps 8 and 9 allow supplying the fluids apportioned in small portions, even in the form of drops, which enables a very precise dosing in respect of weight in conjunction with the weighing cell 24. In the example, filters 5 to 7 are integrated in the associated pump 8, 9 or 10.

The apparatus is provided for the use on a fully automatic machine for the production of lenses, especially which are cut as ophthalmic glasses and mounted in spectacles. Each lens is produced according to a separate recipe. The lens is produced in such a way that a monomer or monomer mixture is filled into the mold cavity 17 and is then polymerized. The fluid is supplied via the hollow needle 16 whose tip opens at the upper end into the mold cavity 17. The mold cavity 17 is formed by two molds 25, 26 and a sealing element 27 and is inclined by a predetermined angle in relation to the vertical line, so that the fluid flows downwardly on the inside 25A of the one mold 25 and successively fills the mold cavity 17. The mold cavity 17 is not sealed off in respect of pressure to the ambient environment. It is therefore under atmospheric pressure. FIG. 2 shows the mold cavity 17 on a scale that is enlarged by several times.

The machine comprises several units, which are a storage unit for storing a plurality of molds, a transport system for transporting the molds and the mold cavity, a joining station in which the two molds are joined with a sealing element into the mold cavity, a filling station where the monomer is cast into the mold cavity, a UV station where the monomer is polymerized and partly cured and thus a lens is formed, a furnace where the lens is completely cured, and a separating station where the finished lens is separated from the mold cavity. The machine is controlled by a computer. The geometric data of the molds are stored in the computer.

Tank 4 is empty and in the cleaned state at the beginning. Containers 2 and 3 contain the starting substances, which in this example is a fluid monomer each, which are mixed and degassed and are then ready as a monomer mixture for the casting of the lenses. The process valve 15 is closed. The method in accordance with the invention for the mixing and degassing of the initial substances and the casting of the lenses comprises a preparatory phase, and optionally a waiting phase, and a production phase with the following method steps:
A) Providing at least two fluids in separate containers which are used as starting substances.
   It is assumed below that the number of starting substances is two. If the number of starting substances is higher, the method needs to be adjusted accordingly.
B) Filling of tank 4 according to the following sub-steps:
B1) Pumping of fluid from the first container 2 into the tank 4 until the weighing cell 24 shows a first predetermined value. Valve 19 is closed thereafter, so that the container 2 and the tank 4 are separated from one another in respect of pressure.
B2) Pumping of fluid from the second container 3 into the tank 4 until the weighing cell 24 shows a second predetermined value. Valve 20 is closed thereafter, so that the container 3 and the tank 4 are separated from one another in respect of pressure.
   Fluids can be pumped into tank 4. If the substance to be filled is not a fluid but a powder for example, then it is conveyed in a respective adequate manner into the tank.
C) Subjecting tank (4) to vacuum at the latest after step B2.

As can be seen from FIG. 2, the connecting lines 18 from the containers 2 and 3 to the tank 4 end at the top at the cap of the tank. The fluid therefore falls down in drops during the filling. Foam is produced thereby. In order to keep the development of foam as low as possible, the tank 4 is preferably subjected to vacuum already before step B1, i.e., step C preferably already occurs before step B1.

The starting substances are filled according to weight. The weighing cell 24 loaded by tank 4 allows achieving the desired weight of the fluid to be filled and thus the ratio of the two fluids with high precision, especially in connection with the apportioned supply of the fluid by the membrane pump 8 or 9, respectively.
D1) Mixing of the fluids in tank 4.
   The mixing of the fluids occurs by stirring with the agitator 23 during a predetermined period of time τ1. The speed of the agitator 23 is relatively low, so that as little foam as possible is produced.
D2) Cleaning of the fluid in tank 4. This step is optional.
   Even when the tank 4 has been cleaned thoroughly prior to filling with the fluids, impurities can still have remained. In order to filter out such impurities, both valves 21 and 22 are opened and the fluid is pumped during a predetermined period of time 12 with the circulation pump 10 in a closed circuit through a third filter 7. Afterwards both valves 21 and 22 are closed again.
E) Degassing of the fluid in tank 4.
   Degassing occurs by stirring with the agitator 23 during a predetermined period of time τ₃. The speed of the agitator 23 is again relatively low in order to prevent the development of foam.

The steps D1 and E are preferably different from one another in the respect that the speed of the agitator 23 in step E during degassing is smaller than in step D1 during the mixing. If there is sufficient time, the mixing of the fluids can occur with the same speed of the agitator 23 as the degassing. The method steps D1 and E can therefore also be one single common method step.

The preparation phase has now been completed because the fluid in tank 4 has been thoroughly mixed and degassed, and it is thus prepared ready for use in casting lenses. Until the production phase begins, tank 4 is either held under vacuum or already under slight overpressure. This phase is known as waiting phase.

The temperature of tank 4 is adjusted to a predetermined value which is determined to be so high that the viscosity of the fluid in the tank 4 is sufficiently low in order to enable smooth casting of the lenses. In this example, tank 4 is a thermally inert steel tank. Its temperature is therefore permanently adjusted to a predetermined value although this would only be necessary during the production phase.
F) Casting of the lenses

The shape and size of the mold cavity 17 varies according to the lens prescription. The two molds 25 and 26 are usually arranged on their side facing the mold cavity 17 as cylindrical surfaces 25A and 26A. Towards the edge, the front mold 25 is flattened on its side facing the mold cavity 17, so that a filling opening 28 is obtained which is sufficiently large that the hollow needle 16 can be introduced into the filling opening 28. The narrowest point of the filling opening 28 is relatively small in some combinations of molds. The monomer needs to be filled with a comparatively low flow velocity in such combinations, as otherwise a back-up will form at the narrowest point and the supplied fluid will overflow the mold cavity 17. In other combinations, the narrowest point of the filling opening 28 is relatively large and the monomer can be filled with a comparatively higher flow velocity without forming a back-up. In certain glasses (such as the one shown in FIG. 2), the narrowest point of the filling opening 28 is virtually always comparatively large and not critical for the filling. In other glasses (as shown in FIG. 3) whose optical axis is designated with reference numeral 30, the narrowest point is often very narrow. The computer determines on the basis of the lens prescription which two molds 25 and 26 need to be collected from the storage unit for forming the mold cavity 17 and at what distance and in which relative rotational position with respect to one another it is necessary to position the molds 25 and 26. The computer further calculates from the geometrical data of the molds 25 and 26 and the lens prescription how large the distance D is at the narrowest point of the filling opening 28 and determines the pressure which needs to be applied to tank 4 so that the mold cavity 17 can be filled with optimal flow velocity of the fluid. Optimal flow velocity means that the flow velocity is as high as possible on the one hand so that the time required for filling the mold cavity 17 is as short as possible, and the flow velocity is slow enough so that no back-up is formed at the narrowest point of the filling opening 28. In the example, the pressure can be set by means of the pressure regulator 11 to n different discrete pressure levels p₁ to pₙ, it is n=8 for example. Each pressure level p₁ to pₙ is associated with a range of distance D, so that the computer can choose the associated pressure level pᵢ from the values p₁ to pₙ after the calculation of distance D.

A predetermined pressure level is built up at the latest at the beginning of the production phase, which pressure level is above atmospheric pressure. Pressure build-up occurs slowly in order to avoid the production of air bubbles in the fluid. Once the pressure has been built up, one lens after the other can be cast. The casting of each lens occurs according to the steps:
G) Increasing or lowering the pressure to a pressure level pₖ which is designed for optimal flow velocity according to distance D;
H) opening of the process valve 15;
I) closing of the process valve 15 once the mold cavity 17 has been filled.

The change of the pressure in step G occurs carefully, so that no air bubbles are produced. Since the pressure prevailing in tank 4 lies above atmospheric pressure, fluid flows into the mold cavity 17 once the process valve 15 is opened. The pressure level in tank 4 determines the flow velocity.

It is principally also possible to use only one single pressure level and to not control the flow velocity. However, the casting of a large mold cavity will then take a respectively long period of time. In this case, the predetermined pressure level is determined for the smallest expected distance D of the filling opening 28 of all possible mold cavities and the step G is omitted.

The process valve 15 is preferably a valve that switches in a bubble-free manner and further shows a back-suction effect in the closed state which prevents the flowing of fluid before and after the casting of a lens. A suitable valve is the valve LVC23U-S06 of the Japanese company SMC for example. The use of a bubble-free switching valve ensures that no bubbles are produced when the valve is switched on or off.

A further hollow needle 29 which is pressurized with air is preferably used as a sensor for detecting when the mold cavity 17 is filled with fluid, i.e., when the fluid filled into the mold cavity 17 has reached a predetermined filling level, so that a very low air flow escapes permanently from the hollow needle 29. Once the fluid filled into the mold cavity 17 has reached the tip of the hollow needle 29, the pressure in the hollow needle 29 will rise very rapidly. The pressure in the hollow needle 29 is measured by means of a pressure sensor. The pressure rise generates the signal for triggering step I, i.e., for closing the process valve 15.

Tank 4 is advantageously dimensioned to be so large that a tank filling will be sufficient for producing a large number of lenses, e.g. in order to enable the casting of lenses for one working day. The production of the lenses is then made in such a way that the tank 4 is refilled and prepared during the night according to steps B, C, D1 and E or also all steps B through E, so that during the day lenses can be produced from the morning to the evening. Tank 4 is usually not completely emptied by the evening. It is filled up to a predetermined level in the following night. If production is to be increased to more than one shift, tank 4 can be enlarged or two such apparatuses can be used in an alternating manner.

What is claimed is:

1. A method for mixing a fluid with at least one further substance and degassing of the mixture and for delivering the mixture, comprising a preparation phase with the method steps of
providing at least two starting substances in separate containers, with at least one of the starting substances being a fluid;
conveying one starting substance after the other from its container into the tank, the tank disposed on a weighing cell and a filling quantity of each starting substance conveyed into the tank measured with the weighing cell, and
stirring the substances in the tank in order to mix and degas the filled substances;
and a production phase, in which the tank is pressurized with compressed air in order to supply the fluid mixture from the tank to an output line, having the following method steps:
opening a process valve arranged in the output line in order to start the delivery, and
closing the process valve in order to stop the delivery.

2. The method according to claim 1, wherein the step of stirring comprises stirring with a first stirring speed at first and thereafter with a second stirring speed, with the second stirring speed being smaller than the first stirring speed.

3. The method according to claim 1 for producing lenses by casting, in which the output line leads to a hollow needle whose tip opens into a mold cavity delimited by two molds and a sealing element, with the mold cavity being under atmospheric pressure, the method further comprising:
prior to the step of opening the process valve bringing the pressure level of the pressure exerted by the compressed air in the tank to a value which depends on a distance at a narrowest point of a filling opening of the mold cavity, with the pressure level increasing continuously or in discrete steps with increasing distance.

4. The method according to claim 2 for producing lenses by casting, in which the output line leads to a hollow needle whose tip opens into a mold cavity delimited by two molds and a sealing element, with the mold cavity being under atmospheric pressure, the method further comprising:
prior to the step of opening the process valve bringing the pressure level of the pressure exerted by the compressed air in the tank to a value which depends on a distance at a narrowest point of a filling opening of the mold cavity, with the pressure level increasing continuously or in discrete steps with increasing distance.

5. The method according to claim 3, further comprising:
using a further hollow needle as sensor for detecting when the mold cavity is filled with fluid by:
pressurizing the further hollow needle with air, and
generating a closing command for the process valve upon detection of a pressure rise in the further hollow needle.

6. The method according to claim 4, further comprising:
using a further hollow needle as sensor for detecting when the mold cavity is filled with fluid by:
pressurizing the further hollow needle with air, and
generating a closing command for the process valve upon detection of a pressure rise in the further hollow needle.
